(19) United States
(12) Patent Application Publication
(10) Pub. No.: US 2004/0168558 A1
(43) Pub. Date: Sep. 2, 2004

(54) Cutting machine for napped cloth

(75) Inventors: Yoshiaki Miyake, Minamiashigara-shi (JP); Terumi Mori, Minamishigara-shi (JP); Hidetoshi Kawasaki, Minamiashigara-shi (JP); Kazunori Mizuno, Minamiashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/699,798

(22) Filed: Nov. 4, 2003

(30) Foreign Application Priority Data
Jun. 11, 2002 (JP) 322575/2002

(51) Int. Cl. B26D 7/02; B26D 5/08

(52) U.S. Cl. 83/456; 83/936; 83/597; 83/613

(57) ABSTRACT

A cutting machine for napped cloth prevents fray and dropout of fabric during cutting, and inhibits shortening of the life of a cutter. An interconnected body formed by a plurality of metallic body plates interconnected by a long light shielding ribbon with adhesive, formed by applying a sealing agent and an adhesive on a surface opposite a napped surface of a napped cloth having a single napped surface, is conveyed by a conveying means. The interconnected body is conveyed so that a void area between adjacent metallic body plates is positioned at a predetermined cutting position between lower and upper receiving surfaces. The light shielding ribbon with adhesive is sandwiched and fastened from both sides by a fastener part, and then this light shielding ribbon with adhesive is cut by advancing a cutter through a cutting part from the napped surface side.

### BACKGROUND OF THE INVENTION

1. Field of the Invention

This invention relates to a cutting machine for napped cloth, and particularly to a cutting machine for napped cloth which cuts a napped cloth which is napped on a single side thereof.

2. Description of the Related Art

A cassette (referred to as a cartridge as well) which rolls up and houses a photographic roll film is known. This cassette comprises a cylindrical body part, a spool shaft which is housed in this cylindrical body part and serves as an shaft for rolling up the film, and caps which close both sides in a direction in which the cylindrical body part extends. In addition, a slit opening is formed on a part of this cylindrical body part in order to pull the film out from the cylindrical body part. The slit opening extends in the direction that the cylindrical body part extends. A light shielding cloth referred to as a teremp to prevent light from entering into this opening is provided on an inner wall of the slit opening.

As the foregoing light shielding cloth, a cloth is known wherein: two layered woven cloths (or knitted cloths) are inwoven (knitted) and interconnected by pile threads; and the pile threads are cut along the cloth face between the two cloths to form a napped surface in which a great number of pile threads are raised on a single side of the cloth face.

The foregoing cylindrical body part of the cassette is formed by rolling up a metallic body plate in a substantially cylindrical shape with the light shielding cloths adhered. The light shielding cloths are adhered to edges on both sides of the body plate which is made by cutting a metal plate in a predetermined shape. Then, the foregoing slit opening is formed by layering the foregoing edges on the both sides to which the foregoing light shielding cloths are adhered. The foregoing pile thread prevents light from entering into the cassette by contacting the film pulled out from the cassette through the light shielding cloths arranged on the inner wall of the opening.

The foregoing body plate with the light shielding cloths adhered thereto is formed as below. That is, a number of metallic body plates are aligned and conveyed continuously. At the same time, 2 long light shielding cloths to which adhesive is applied on the opposite face of the napped surface are respectively adhered to the edges on the both sides of the foregoing aligned and conveyed body plates. The body plates are interconnected by the long light shielding cloths. After that, a cutter blade is advanced in between adjacently conveyed body plates, and the long light shielding cloths are cut to separate each body plate. Consequently, the body plate with the light shielding cloths adhered thereto, constituted by the light shielding cloths adhered to the metal plate, is formed (for example, refer to Japanese Patent Publication No. 5(1993)-53256 and Japanese Unexamined Patent Publication No. 7(1995)-301888). Here, the foregoing light shielding cloths are cut by advancing the cutter through the light shielding cloths from the side opposite the napped surface.

Meanwhile, the process to form the foregoing napped surface by inweaving (knitting) the pile threads into the woven cloth (or knitted cloth) is complicated and requires time, leading to raised production cost of the light shielding cloth. Therefore, in recent years, a napped cloth which is a light shielding cloth requiring no pile threads has been in practical use.

This napped cloth is shown in FIG. 7. Warps K are provided, aligned along a longitudinal direction which is the foregoing longitudinal direction of the light shielding cloth. A napped surface 12 is formed by inweaving wefts E over a plurality of warps K in a lateral direction approximately orthogonal to this longitudinal direction, and by administering napping treatment to form naps 11 by raising fabric in areas wherein the wefts E stride over the plurality of warps K (for example, refer to Japanese Unexamined Patent Publication No. 8(1996)-15825). Here, the wefts mean threads which are inwoven over a plurality of threads, and to which the napping treatment is administered. Generally, in the napped cloth, on the opposite side of the side to which the napping treatment is administered, a weft is inwoven over one warp. However, even in the case wherein a weft is inwoven over a plurality of warps on the opposite side of the side to which the napping treatment is administered, the number of the wefts over the warps on the side to which the napping treatment is administered is greater than the number of the wefts over the warps on the opposite side of the side to which the napping treatment is administered.

However, when the light shielding cloth comprised of the napped cloth whose napped surface is formed by administering the napping treatment to wefts is cut by advancing the cutter through from the opposite side of the napped surface as in the light shielding cloth formed by raising the foregoing pile threads, since the wefts are inwoven over the plurality of warps on the napped surface side, spaces between warps which support wefts when the wefts receive the force by the cutter which is let through from the opposite side of the napped surface become wide, i.e. the wefts become infirm. Therefore, the wefts are pulled out to the napped surface side, pulled apart, and cut by the cutter. For example, in an area S1 wherein a weft E2 strides over warps K2, K3 and K4 on the napped surface 12 side, as to the warps supporting the area S1 of the weft E2, a space between a warp K1 and a warp K5 becomes wide, the weft E2 in the area S1 becomes infirm, the weft E2 is pulled apart and cut by the cutter. Then, the cutter blade is abraded by the weft. Thus, not only is cut resistance increased, but also the cutter blade is worn away.

Because of this, there is a problem that wear of the cutter blade is progressed, and the life of the cutter becomes short. In addition, there is a problem that fibers, which fly out in a frayed state from a cross section of the weft which is pulled apart and cut, drops out during a process of installing the film or when a customer pulls out the film during use. These fibers may adhere to photosensitive surfaces of the film, or may damage the photosensitive surfaces of the film.

The foregoing problems not only occur when the napped cloth used for the cassette as a light shielding cloth is cut, but also occur generally when any napped cloth is cut. In addition, these problems occur when wefts are cut, regardless of an angle made between a cutting direction of the napped cloth by the cutter and a direction in which the wefts extend.

### SUMMARY OF THE INVENTION

In view of the foregoing observations and description, the primary object of the invention is to provide a cutting machine for napped cloth which can prevent fraying and dropout of fibers during a cutting operation, and inhibit the shortening of the life of a cutter.

The cutting machine for napped cloth according to the present invention is a cutting machine for cutting napped cloth having a single napped surface, comprising a cutting means for cutting the napped cloth by advancing the cutter through from the side of the napped surface.

In the foregoing cutting means, it is required that the napped cloth is cut by moving the cutter so that both Vy, the component of velocity in a direction in which the cutter blade extends, and Vx, the component of velocity in a direction orthogonal to the direction where the cutter blade extends are greater than 0. It is preferable that Vx/Vy, a ratio of the component of velocity Vx to the component of velocity Vy satisfies a conditional expression, 0.5<Vx/Vy<2.0.

The foregoing cutting machine for napped cloth may comprise a fastener means to sandwich and fasten the napped cloth from both sides during cutting of the napped cloth.

The foregoing napped cloth can be used as a light shielding cloth for a cassette to house a photographic roll film. The foregoing light shielding cloth for the cassette is arranged on an inner wall of a slit opening of the cassette. On the opposite face of a napped surface of this light shielding cloth, a sealing agent to provide sealing for the light shielding cloth and an adhesive to adhere the light shielding cloth to a metallic body plate are applied, and a sealing agent layer and an adhesive layer are layered in this order. The light shielding cloth is fixed to the inner wall of the slit opening via this adhesive layer.

The cutting machine for napped cloth according to the invention comprises the cutting means to cut the napped cloth by advancing the cutter through from the side having the napped surface. Therefore, it is possible to prevent fray and dropout of the fabric of wefts, and to inhibit shortening of the life of the cutter. When the wefts are cut by the cutter which is advanced through from the napped surface side, the wefts receive cutting force from the napped surface side. However, in this case, spaces between warps supporting the wefts, inwoven over the warps on the opposite side of the napped surface, are narrow, and the wefts can be sharply cut in a firm condition.

When the cutting means is set so that the ratio Vx/Vy of Vy, the component of velocity in a direction in which the cutter blade extends, to Vx, the component of velocity in a direction orthogonal to the direction in which the cutter blade extends, satisfies the conditional expression, 0.5<Vx/Vy<2.0, it becomes possible to prevent an increase in machine size associated with an increased movement speed of the cutter in the direction wherein the cutter blade extends (0.5>Vx/Vy), and also to prevent a decrease in sharpness of the cutter due to an increased movement speed of the cutter in the direction orthogonal to the direction wherein the cutter blade extends (Vx/Vy>2.0).

Further, when this cutting machine for napped cloth comprises the fastener means to sandwich and fasten the napped cloth from the both sides during cutting of the napped cloth, firmness of the wefts in cutting the napped cloth can be further reinforced. Therefore, it is possible to further inhibit fray and dropout of the fabric, and shortening of the life of the cutter.

Here, especially, when the napped cloth is used as a light shielding cloth for the cassette, which disfavors intrusion of dust, and wherein replacement cycle of the cutter largely affects productivity, significant effects, such as preventing fray and dropout of the fabric of the wefts and inhibiting shortening of the life of the cutter, can be realized.

### BRIEF DESCRIPTION OF THE DRAWINGS

FIGS. 1A and 1B are side views showing schematic constructions of a cutting machine for napped cloth according to an embodiment of the invention,

FIG. 2 is a cross sectional view showing a cross section when the cutting machine for napped cloth to which a light shielding ribbon with adhesive is fastened is seen along a surface of the light shielding ribbon with adhesive,

FIG. 3 is a view showing an interconnected body wherein a plurality of metallic body plates are interconnected by the light shielding ribbons with adhesive,

FIG. 4 is an enlarged sectional view showing the light shielding ribbon with adhesive,

FIGS. 5A and 5B are views showing L-grooves of cutters,

FIG. 6 is a view showing a condition that the light shielding ribbon with adhesive is cut by advancing the cutter through from a side of a napped surface,

FIG. 7 is a view showing a condition that the light shielding ribbon with adhesive is cut by advancing the cutter through from a side of the adhesive, and

FIGS. 8A and 8B are side views showing schematic constructions of a bending side of the cutting machine for napped cloth.

### DESCRIPTION OF THE PREFERRED EMBODIMENT

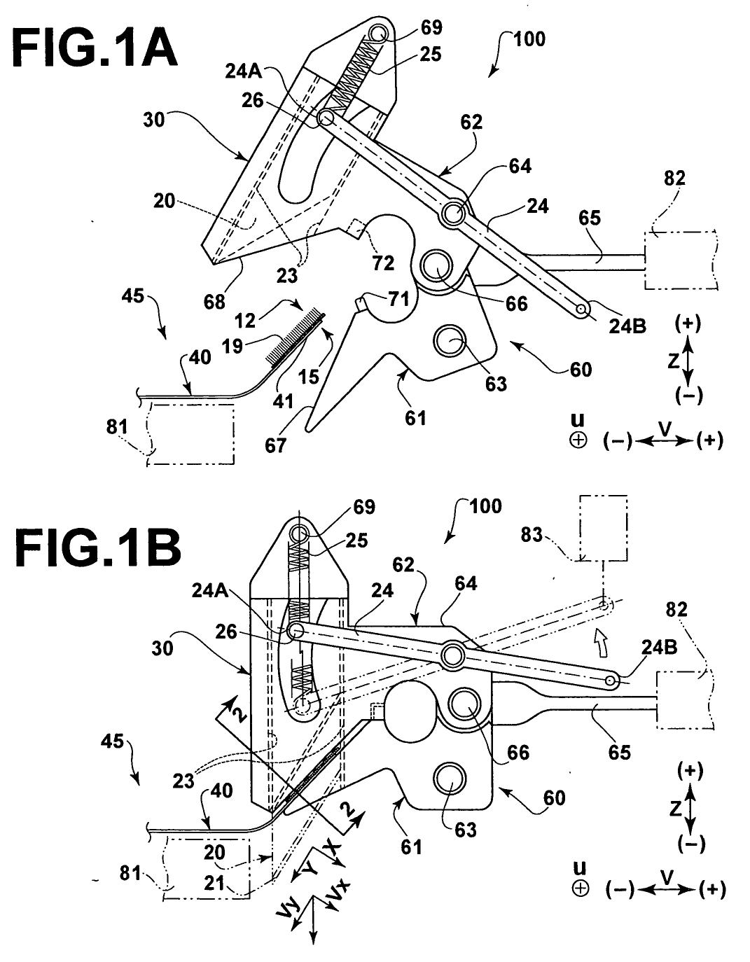

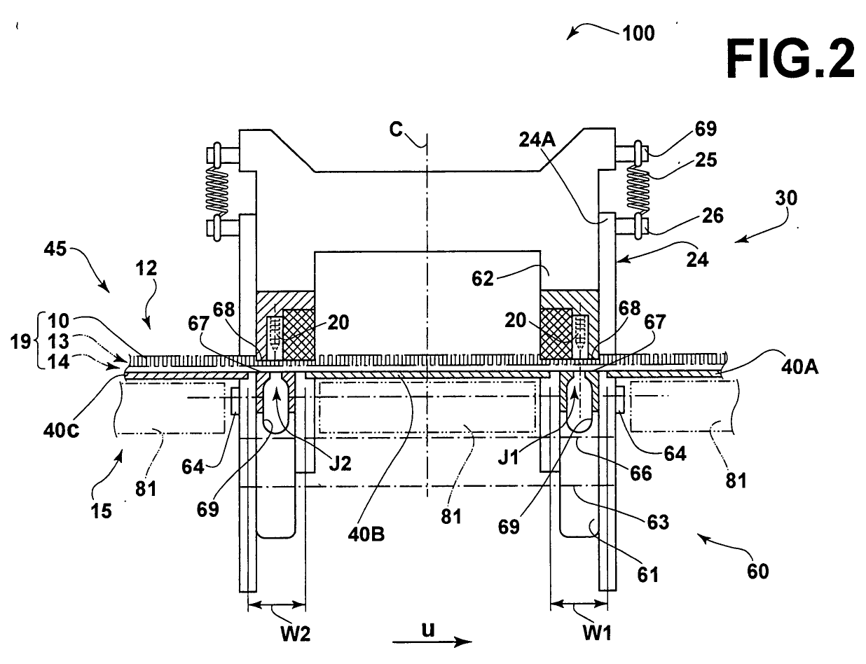

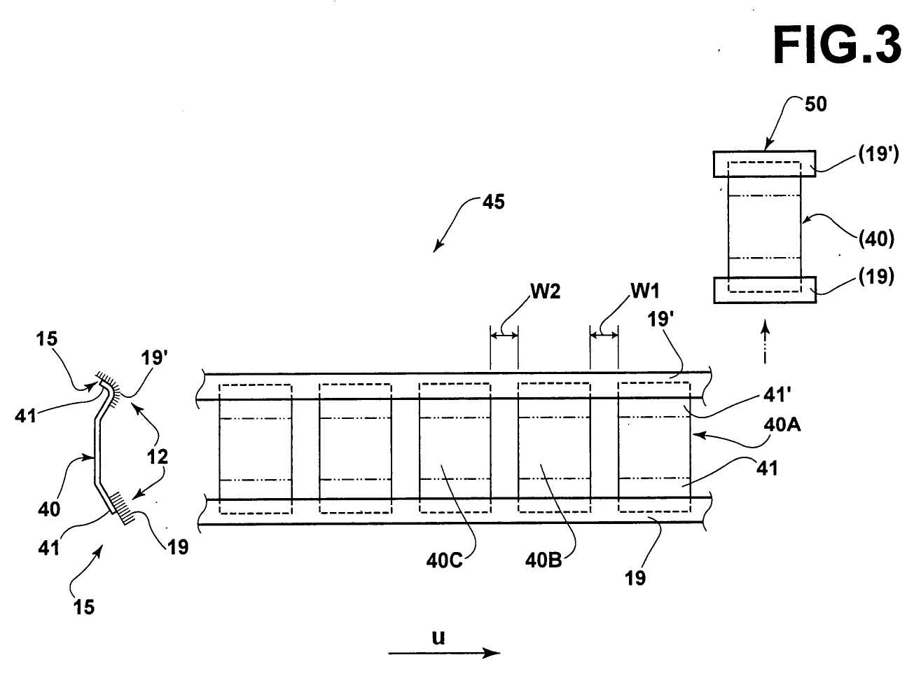

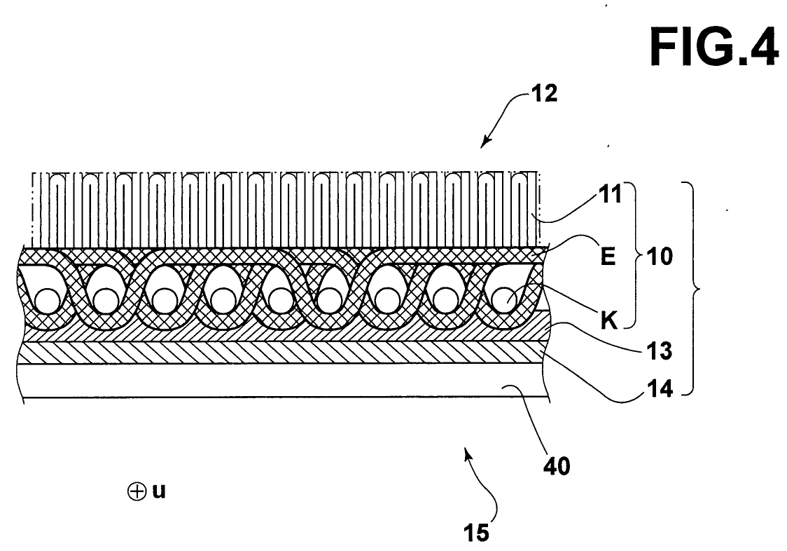

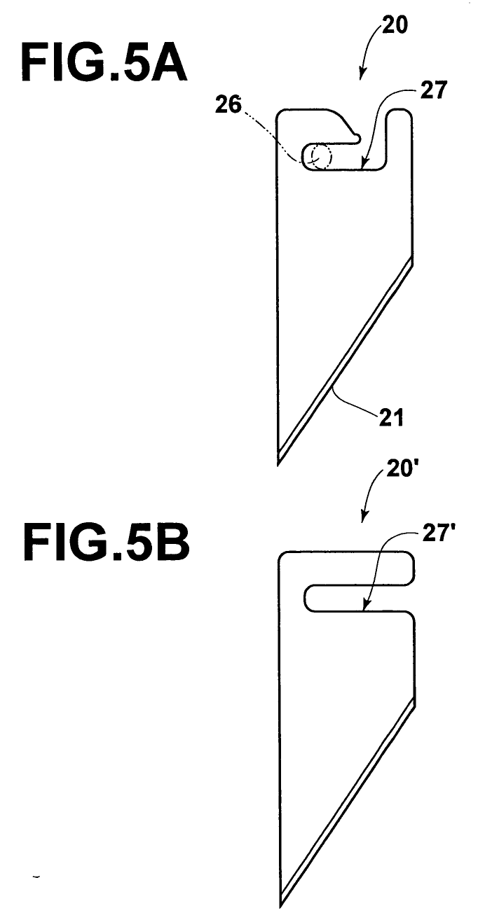

An embodiment of the invention will be described hereinbelow with reference to the accompanying drawings. FIGS. 1A and 1B show lateral surfaces of a cutting machine for napped cloth according to an embodiment of the invention. FIG. 1A is a side view showing a condition before sandwiching a light shielding ribbon with adhesive from both of its sides, and FIG. 1B is a lateral view showing a condition of sandwiching, fastening from both sides, and cutting the light shielding ribbon with adhesive. FIG. 2 is a cross sectional view taken along line 2-2 of FIG. 1B when the cutting machine for napped cloth to which the light shielding ribbon with adhesive is fastened is seen from a direction along a surface of the light shielding ribbon with adhesive. FIG. 3 is a view showing an interconnected body wherein a plurality of metallic body plates are interconnected by the light shielding ribbons with adhesive. FIG. 4 is an enlarged sectional view showing the light shielding ribbon with adhesive which is seen from a direction in which warps extend. FIGS. 5A and 5B are views showing L-grooves of cutters.

The cross sectional view shown in FIG. 2, taken along the line 2-2 of FIG. 1B is symmetrical with respect to a center line C, and some overlapping symbols in right and left sides are omitted.

As shown in FIGS. 1 to 5, a cutting machine for napped cloth 100 according to the embodiment of the invention comprises a cutting means 30 for cutting a napped cloth 10 having naps 11 on a single surface thereof by advancing a cutter 20 through from a napped surface 12 side having the naps 11 of the napped cloth 10, and a fastener means 60 for sandwiching and fastening this napped cloth 10 from both of its sides during cutting of the napped cloth 10.

The cutting means 30 moves the cutter so that a ratio Vx/Vy of Vy, the component of velocity in a Y direction (the direction indicated by arrow Y in FIG. 1B) in which a blade 21 of the cutter 20 extends, to Vx, the component of velocity in an X direction (the direction indicated by arrow X in FIG. 1B) orthogonal to the foregoing Y direction in which the blade 21 of the cutter 20 extends satisfies a conditional expression, 0.5<Vx/Vy<2.0.

The foregoing napped cloth 10 is a light shielding cloth arranged on an inner wall of a slit opening of a cassette for housing a roll of photographic film. This cutting machine for napped cloth 100 cuts, at predetermined positions, an interconnected body 45 comprising a plurality of metallic body plates 40 which are interconnected by a light shielding ribbon with adhesive 19 formed by applying an adhesive and the like to the napped cloth 10, and cuts out a light shielding cloth adhered body plate comprising individual metallic body plates 40 to which the light shielding ribbon with adhesive 19 is adhered.

The metallic body plate 40 is to become a cylindrical body part of the cassette. In the light shielding ribbon with adhesive 19, a sealing agent layer 13 and an adhesive layer 14, which are formed by applying a sealing agent and an adhesive on a surface opposite the napped surface 12 of the napped cloth 10 are layered in this order. Hereinafter, the surface on which the adhesive layer 14 is layered, i.e. the surface opposite the napped surface 12 of the light shielding ribbon with adhesive 19, will be referred to as an adhesive face 15.

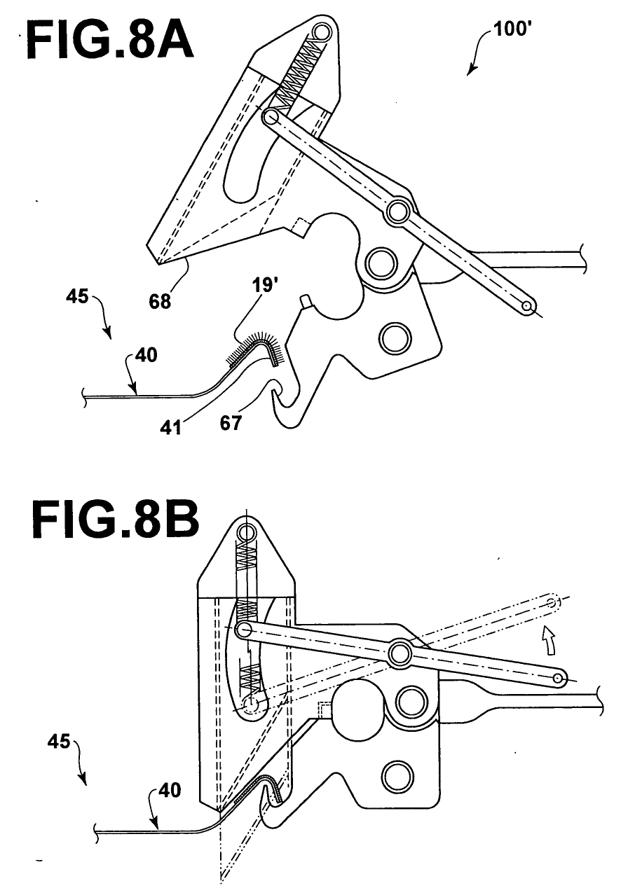

The foregoing interconnected body 45 is formed by adhering long light shielding ribbons with adhesive 19 and 19′ (the light shielding ribbon with adhesive 19′ is a light shielding ribbon with adhesive on a bending side of the metallic body plate 40) to edges 41 and 41′ on both sides in a direction orthogonal to a conveying direction U of the metallic body plates 40 aligned in the conveying direction U to be described later (the direction indicated by arrow U in the figure, and hereinafter referred to as “conveying direction U”) via the adhesive layer 14 (refer to FIG. 3). This interconnected body 45 is conveyed in the conveying direction U by conveying means 81, and positioned in a predetermined position of the cutting machine for napped cloth 100. After that, the light shielding ribbon with adhesive 19 which interconnects adjacent metallic body plates 40 is cut by this cutting machine for napped cloth 100. The light shielding ribbon with adhesive 19′ which interconnects adjacent metallic body plates 40 is cut by a cutting machine for napped cloth 100′ on the bending side shown in FIG. 8. The cutting machine for napped cloth 100′ on the bending side which cuts the light shielding ribbon with adhesive 19′ on the bending side has the same construction and operation as in the cutting machine for napped cloth 100, except that a lower receiving face 67′ and an upper receiving face 68′ to sandwich and fasten the light shielding ribbon with adhesive have different shapes from those in the cutting machine for napped cloth 100. Hereinafter, a description will be given regarding the cutting machine for napped cloth 100. Here, FIG. 8A is a lateral view showing a condition before the cutting machine for napped cloth 100′ on the bending side sandwiches the light shielding ribbon with adhesive from the both sides, and FIG. 8B is a lateral view showing a condition in which the cutting machine for napped cloth 100′ on the bending side sandwiches, fastens from both sides, and cuts the light shielding ribbon with adhesive 19′.

The fastener means 60 comprises a lower receiving part 61 having a lower receiving face 67 which receives the light shielding ribbon with adhesive 19 from the adhesive face 15 side, and an upper receiving part 62 having an upper receiving face 68 which receives the light shielding ribbon with adhesive 19 from the napped surface 12 side. In the fastener means 60, the light shielding ribbon with adhesive 19 is sandwiched and fastened between the lower receiving face 67 and the upper receiving face 68.

The fastener means 60 further comprises a lower receiving pin 63 which is fixed on the machine body (not shown in the figure), and which supports the lower receiving part 61 so that the lower receiving part 61 is rotatable around the foregoing conveying direction U, an upper receiving pin 64 which is fixed on the machine body, and which supports the upper receiving part 62 so that the upper receiving part 62 is rotatable around the conveying direction U, and a piercing pin 66 which is arranged between the lower receiving pin 63 and the upper receiving pin 64, which pierces the lower receiving part 61, the upper receiving part 62, and a receiving part switching arm 65 to be described later, in the conveying direction U, and which supports the lower receiving part 61 and the upper receiving part 62 so that the lower receiving part 61 and the upper receiving part 62 are rotatable. A link mechanism is constructed by the lower receiving pin 63, the upper receiving pin 64 and the piercing pin 66, and the lower receiving part 61 and the upper receiving part 62 supported by these pins.

That is, when the receiving part switching arm 65 is driven in a +V direction (indicated by an arrow in the figure) orthogonal to the conveying direction U by a reciprocation drive means 82, the position of the piercing pin 66 is moved in the +V direction without movement of the positions of the lower receiving pin 63 and the upper receiving pin 64, the lower receiving part 61 and the upper receiving part 62 are respectively rotated around the lower receiving pin 63 and the upper receiving pin 64 in directions opposite from each other, the lower receiving face 67 and the upper receiving face 68 are moved in a direction in which the lower receiving face 67 and the upper receiving face 68 approach each other, and the lower receiving face 67 and the upper receiving face 68 are closed.

Meanwhile, when the receiving part switching arm 65 is driven in a −V direction, the position of the piercing pin 66 is moved in −V direction, the lower receiving part 61 and the upper receiving part 62 are rotated respectively around the lower receiving pin 63 and the upper receiving pin 64 in directions opposite from the above mentioned directions, the lower receiving face 67 and the upper receiving face 68 are moved in a direction in which the lower receiving face 67 and the upper receiving face 68 separate from each other, and the lower receiving face 67 and the upper receiving face 68 are opened.

A part of the upper receiving part 62 serves functions for both the cutting means 30 and the foregoing fastener means 60. The cutting means 30 comprises the cutter 20, a guide aperture 23 which serves as a guide when moving the cutter 20 through the interior of the upper receiving part 62, a cutter drive arm 24 which is rotatable around the upper receiving pin 64 in such a manner that an edge 24A on one end supports the cutter 20 and the upper receiving pin 64 supports a central part, a spring 25 which is hung and fixed between the edge 24A and a hook 69 which is arranged in the upper receiving part 62 above the guide aperture 23 (+Z direction in the figure), and which generates a force to pull the cutter 20 up in +Z direction via the edge 24A, and a cutter drive means 83 which moves the cutter 20 supported by the edge 24A in a −Z direction by pulling an edge 24B which is on the opposite side of the edge 24A side in the cutter drive arm 24 in the +Z direction.

As shown in 5A, in the cutter 20, an L-groove 27 is provided on an edge on the opposite side of the side where the blade 21 extends. This groove may alternatively be formed in the shape of a straight line as a groove 27′ provided in a cutter 20′ shown in FIG. 5B. The shape of the cutter 20′ is the same as that of the cutter 20 except for the shape of its groove. Descriptions will be given hereinbelow only regarding the cutter 20.

A shaft 26, which comprises a part of the edge 24A and which extends in the conveying direction U, is inserted in the foregoing L-groove 27. Via this shaft 26, the cutter 20 is reciprocated through the guide aperture 23 in the Z direction. This cutter 20 has a thickness of 0.2 mm to 0.5 mm. On a lateral face of the blade 21, grinding is performed with abrasives of a size of #400 to #800. Further, as the cutter 20, a cutter is used in which nicked edges, rust, and adherent dust are not detected when observed with a tool maker's microscope at 50× magnification.

Here, movement of the cutter 20 in the +Z direction is driven by a force of the spring 25, and movement of the cutter 20 in the −Z direction is driven by the cutter drive means 83. The cutter drive means 83 does not restrict movement of the cutter 20 except when the cutter 20 is moved in the −Z direction. The foregoing drive methods such as the conveying means 81, the reciprocation means 82, and the cutter drive means 83 can be composed of machine elements and the like known in the related art. More specifically, for example, as a movement guide mechanism, a ball rail system, an air slide system and the like can be adopted. As a driving force transfer mechanism, a rack-and-pinion mechanism, a ball screw and ball bushing mechanism, a belt drive mechanism, a piston and cylinder mechanism and the like can be adopted. As a drive source, a rotating motor, a linear motor, a hydraulic actuator, a pneumatic actuator and the like can be adopted.

Next, descriptions will be given regarding the operation of the foregoing embodiment.

The interconnected body 45 comprised of metallic body plates 40A, 40B, 40C, and so on which are interconnected by the light shielding ribbon with adhesive 19 is conveyed between the lower receiving face 67 and the upper receiving face 68 whose space is broadened on the napped surface 12 side in the +Z direction by the conveying means 81. A void area W1 between adjacent metallic body plates 40A and 40B and a void area W2 between adjacent metallic body plates 40B and 40C are respectively conveyed and stopped at cutting positions J1 and J2 between the lower receiving face 67 and the upper receiving face 68 (refer to FIG. 2). The receiving part switching arm 65 is moved in the +V direction by drive of the reciprocation means 82, the light shielding ribbon with adhesive 19 is sandwiched between the lower receiving face 67 and the upper receiving face 68, and its position is fixed.

Next, the cutter drive means 83 pulls the edge 24B of the cutter drive arm 24 up in the +Z direction to move the cutter 20 supported by the edge 24A in the −Z direction.

The cutter 20 proceeds through the guide aperture 23 in the −Z direction, and cuts the light shielding ribbon with adhesive 19 from the napped surface 12 side. Thereby, the light shielding ribbon with adhesive 19 is simultaneously cut at the void areas W1 and W2 which are located on both sides of the metallic body plate 40.

When the light shielding ribbon with adhesive 19 is cut, the force by the cutter drive means 83 pulling the edge 24B up in the +Z direction is released, the edge 24A is pulled up by the force of the spring 25 in the +Z direction, and the cutter 20 is housed in the guide aperture 23.

After that, by drive of the reciprocation means 82, the receiving part switching arm 65 is moved in the −V direction, a space between the lower receiving face 67 and the upper receiving face 68 is widened, the metallic body plates 40A and 40B adhered with the light shielding ribbon with adhesive 19 are separated from the interconnected body 45 as a light shielding cloth adhered body plate 50, and taken out from the conveying means 81. After that, the metal plate for the body 40C in the interconnected body 45 is conveyed to a predetermined position (position wherein the metal plate for the body 40A was arranged before cut), by the conveying means 81 and cut in the same manner as described above.

Here, when the light shielding ribbon with adhesive 19 is sandwiched and fastened between the lower receiving face 67 and the upper receiving face 68, the position of the upper receiving part 62 is precisely positioned in relation to the position of the lower receiving part 61, by fitting a positioning protrusion 71 arranged in the lower receiving part 61 to a positioning recess 72 arranged in the upper receiving part 62. Consequently, the cutter 20 which proceeds in the −Z direction by being guided by the guide aperture 23 of the upper receiving part 62 is precisely inserted in the center of a groove 69 of the lower receiving part 61 through the light shielding ribbon with adhesive 19, and displacement in the conveying direction U of the lower receiving face 67 and the upper receiving face 68 which are placed opposite to each other can be prevented.

During cutting of the light shielding ribbon with adhesive 19 by the cutter 20, a bending moment to the napped cloth 10 is set to be as small as possible. A cutter passing slit width G in the foregoing groove 69 through which the cutter 20 passes is set to the range of: the thickness of the cutter 20+0.4 mm<G<the thickness of the cutter 20+2.0 mm. A center misalignment M when the cutter 20 passes through the cutter passing slit in the groove 69 is set to the range of −0.1<M<+0.1.

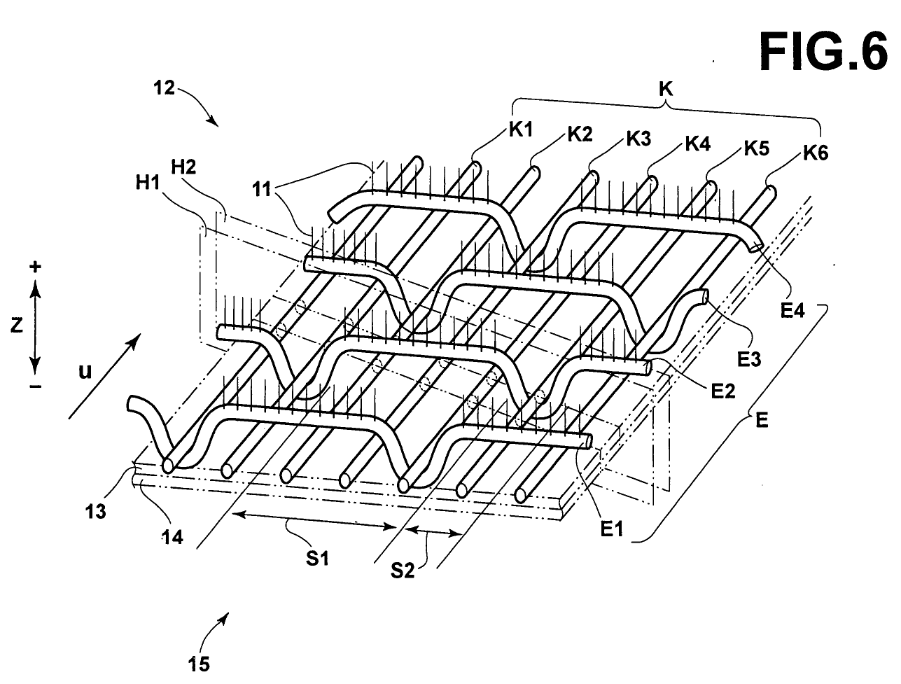

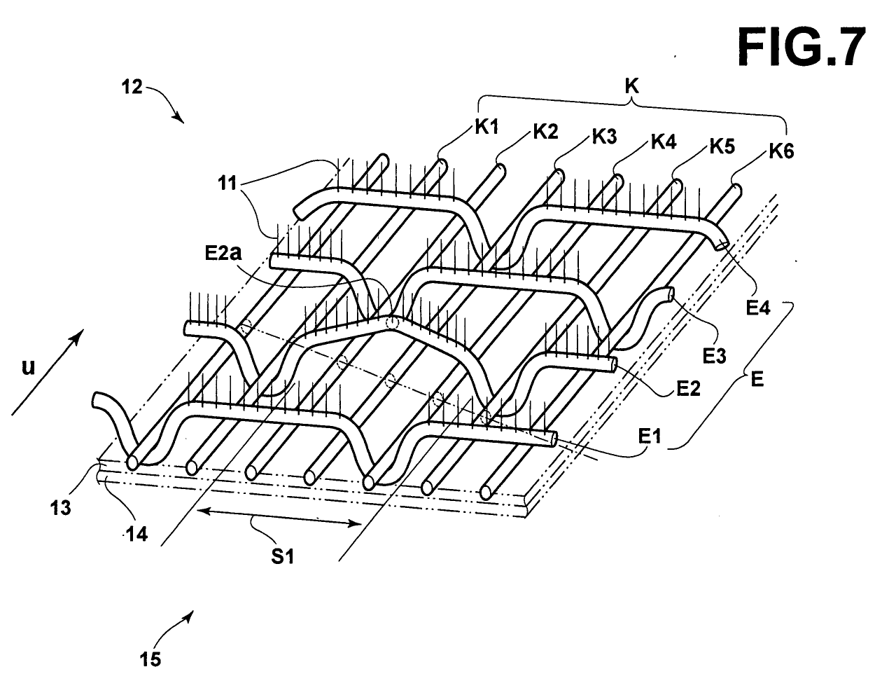

Here, the effects of preventing fray and dropout of the fabric and inhibiting shortening of the life of the cutter during the foregoing cutting will be described with reference to FIGS. 6 and 7. FIG. 6 is a view showing a condition that the light shielding ribbon with adhesive is cut by advancing the cutter through from the napped surface side, and FIG. 7 is a view showing a condition that the light shielding ribbon with adhesive is cut by advancing the cutter through from the adhesive face side.

As shown in FIG. 6, in the case where the light shielding ribbon with adhesive 19 is cut by advancing the cutter 20 through from the napped surface 12 side to the adhesive face 15 side (in the −Z direction), for example, when the cutter 20 cuts a weft E2 through an area S1 in the weft E2 arranged over 3 warps K2, K3 and K4 on the napped surface 12 side, the blade 21 of the cutter 20 cuts the light shielding ribbon with adhesive 19 through a cutting cross section H1 which passes the weft at a slant. Then, in the vicinity of this cutting area, after the weft E2 is cut, the warps K2, K3, and K4 are cut, and the sealing agent layer 13 and the adhesive layer 14 are further cut. A direction wherein the weft E2 extends is substantially the same direction as a direction wherein the blade 21 of the cutter 20 extends. However, during cutting of the light shielding ribbon with adhesive 19, the direction wherein the weft E2 extends does not accurately correspond to the direction wherein the blade 21 extends. Therefore, in reality, a few wefts are cut in cutting.

Here, during cutting, the area S1 in the weft E2 receives a cutting force in the −Z direction by the cutter 20. However, since the warps K2, K3, and K4 support this area S1, the weft E2 in this area S1 becomes firm. In addition, since the warps K2, K3, and K4 supporting the weft E2 in the foregoing area S1 are supported by the sealing agent layer 13 and the adhesive layer 14, firmness of the weft E2 in the area S1 is further reinforced. Therefore, the weft E2 in the area S1 is sharply cut by the cutter 20.

Further, for example, when the blade 21 of the cutter 20 cuts the light shielding ribbon with adhesive 19 through an area S2 in the weft E2 wherein the weft E2 is arranged over one warp K5 on the adhesive face 15 side, the blade 21 passes through a cutting cross section H2 wherein the weft is cut at a slant. Then, the weft E2 in the area S2 becomes firm since it is supported by the warp K4 and a warp K6 which are adjacently arranged on both sides of the warp K5. In addition, firmness of the weft E2 in the foregoing area S2 and the warps K4 and K6 is reinforced by being supported by the sealing agent layer 13 and the adhesive layer 14. Therefore, the weft E2 in the area S2 is also sharply cut by the cutter 20.

When other wefts E1, E3, E4 and the like are cut, these wefts are also sharply cut by the cutter 20 as described above. That is, by advancing the cutter 20 through from the napped surface 12 side to the adhesive face 15 side, cut resistance becomes small. Consequently, it is possible to inhibit a shortening of the life of the cutter, and to prohibit dropout of the fabric in cutting.

Even in the case where only a napped cloth to which the sealing agent layer and the adhesive layer are not layered is cut, the effect that the foregoing warps support the weft to make the weft firm is the same. Therefore, even in this case, the weft is sharply cut as described above, dropout of the fabric can be prevented, and a shortening of the life of the cutter can be inhibited.

On the other hand, as shown in FIG. 7, in the case where the light shielding ribbon with adhesive 19 is cut by advancing the cutter 20 through from the adhesive face 15 side to the napped surface 12 side (in the +Z direction), for example, when the area S1 in the weft E2 arranged over 3 warps K2, K3 and K4 on the napped surface 12 side is cut by advancing the cutter 20 through from the adhesive face 15 side, in the vicinity of this area, after the adhesive layer 14 and the sealing agent layer 13 are cut and the warps K2, K3, and K4 are cut, the weft E2 is cut. Then, though the weft E2 is supported by a warp K1 and the warp K5, a space between the warp K1 and the warp K5 is wide, so that firmness of the weft E2 in the area S1 becomes weak. Therefore, a cut part E2a of the weft E2 is pulled out toward the napped surface 12 side, pulled apart, and cut by the cutter 20. Consequently, cut resistance becomes large, the life of the cutter becomes short, and fray and dropout of the fabric in cutting increase. Even in cutting only a napped cloth wherein the sealing agent layer and the adhesive layer are not layered, the effect that firmness of the weft becomes weak is the same as described above. Therefore, cut resistance becomes large, the life of the cutter becomes short, and fray and dropout of the fabric in cutting are increased.

More specifically, when the light shielding ribbon with adhesive is cut by advancing the cutter through from the adhesive face side to the napped surface side, the life of the cutter becomes short since its sharpness is lowered due to slight wear of the blade edge. Meanwhile, when the light shielding ribbon with adhesive is cut by advancing the cutter through from the napped surface side to the adhesive face side, a life of the cutter does not become short due to lowered cutting sharpness because of slight wear of an blade edge. Therefore, a ratio of the life of the cutter in the case where the cutter is let through from the adhesive face side, to the life of the cutter in the case where the cutter is let through from the napped surface side becomes approximately 1:1,000.

Here, in order to move the cutter by the cutting means, it is necessary that both Vy, the component of velocity in a direction wherein the cutter blade extends, and Vx, the component of velocity in a direction orthogonal to the direction where the cutter blade extends become larger than 0. However, movement of the cutter by the cutting means is not limited to the case where Vx/Vy, the ratio of the component of velocity Vx to the component of velocity Vy satisfies the conditional expression, 0.5<Vx/Vy<2.0.

The cutting method by the foregoing cutting machine for napped cloth is not limited to application to cutting the light shielding cloth (light shielding ribbon with adhesive) of the cassette for housing the photographic roll film, wherein an adhesive or the like is applied to the napped cloth, but can be applied to cutting napped cloths generally. In addition, when this cutting method is applied, it is not necessary to provide the fastener means to sandwich and fasten the napped cloth from both sides.

The cutting machine for napped cloth is not limited to application to the napped cloth wherein the weft is inwoven over 3 warps, but can be applied to a napped cloth wherein a weft is inwoven over a plurality of warps. More practically, the cutting machine for napped cloth can be applied to a napped cloth wherein a weft is inwoven over 2 to 5 warps.

What is claimed is:

1. A cutting machine for napped cloth to cut a napped cloth having a single napped surface, comprising:
a cutting means for cutting the napped cloth by advancing a cutter through the napped surface.

2. A cutting machine for napped cloth as defined in claim 1, wherein the cutting means cuts the napped cloth by moving the cutter so that both Vy, a component of velocity in a direction wherein a blade of the cutter extends, and Vx, a component of velocity in a direction orthogonal to the direction wherein the blade of the cutter extends become larger than 0.

3. A cutting machine for napped cloth as defined in claim 2, wherein Vx/Vy, a ratio of the component of velocity Vx to the component of velocity Vy satisfies the following conditional expression:
0.5<Vx/Vy<2.0

4. A cutting machine for napped cloth as defined in claim 1, further comprising a fastener means to sandwich and fasten the napped cloth from both sides thereof during cutting of the napped cloth.

5. A cutting machine for napped cloth as defined in claim 2, further comprising a fastener means to sandwich and fasten the napped cloth from both sides thereof during cutting of the napped cloth.

6. A cutting machine for napped cloth as defined in claim 3, further comprising a fastener means to sandwich and fasten the napped cloth from both sides thereof during cutting of the napped cloth.

7. A cutting machine for napped cloth as defined in claim 1, wherein the napped cloth is a light shielding cloth of a cassette for housing a photographic roll film.

8. A cutting machine for napped cloth as defined in claim 2, wherein the napped cloth is a light shielding cloth of a cassette for housing a photographic roll film.

9. A cutting machine for napped cloth as defined in claim 3, wherein the napped cloth is a light shielding cloth of a cassette for housing a photographic roll film.

10. A cutting machine for napped cloth as defined in claim 4, wherein the napped cloth is a light shielding cloth of a cassette for housing a photographic roll film.

11. A cutting machine for napped cloth as defined in claim 5, wherein the napped cloth is a light shielding cloth of a cassette for housing a photographic roll film.

12. A cutting machine for napped cloth as defined in claim 6, wherein the napped cloth is a light shielding cloth of a cassette for housing a photographic roll film.
